(19) United States
(12) Patent Application Publication
(10) Pub. No.: US 2022/0253573 A1
(43) Pub. Date: Aug. 11, 2022

(54) PEOPLE FLOW ESTIMATION DEVICE, PEOPLE FLOW ESTIMATION METHOD, AND PEOPLE FLOW ESTIMATION PROGRAM

(71) Applicant: NIPPON TELEGRAPH AND TELEPHONE CORPORATION, Tokyo (JP)

(72) Inventors: Yusuke TANAKA, Tokyo (JP); Takeshi KURASHIMA, Tokyo (JP); Hiroyuki TODA, Tokyo (JP); Toshiyuki TANAKA, Kyoto (JP)

(73) Assignee: NIPPON TELEGRAPH AND TELEPHONE CORPORATION, Tokyo (JP)

(21) Appl. No.: 17/624,790

(22) PCT Filed: Jun. 29, 2020
(86) PCT No.: PCT/JP2020/025515

§ 371 Date: Jan. 4, 2022

(30) Foreign Application Priority Data
Jul. 10, 2019 (JP) 2019-128428

(51) Int. Cl. G06F 30/20

(52) U.S. Cl. CPC G06F 30/20; G06F 2111/08

(57) ABSTRACT

The parameter estimation section 106 estimates a parameter for transition probability, a parameter for inflow noise, a parameter for outflow noise, and a number of moving people based on inflow data and outflow data so as to optimize an objective function. The inflow data is aggregate data made up of an inflow number of people at each time step for each of plural observation points and the outflow data is aggregate data made up of an outflow number of people at each time step for each of the plural observation points. The objective function is expressed using the inflow data, the outflow data, the number of moving people that is the number of people that have moved between each of the observation points at each time step, the transition probability of a person moving from one of the observation points to another of the observation points for each of respective pairs of the observation points at each time step, inflow noise that is noise in the inflow number of people at each time step for each of the plurality of observation points, and outflow noise that is noise in the outflow number of people at each time step for each of the plurality of observation points.

### TECHNICAL FIELD

Technology disclosed herein relates to a people flow estimation device, a people flow estimation method, and a people flow estimation program.

### BACKGROUND ART

From a privacy standpoint, position information relating to people, as obtained from sensors, a global positioning system (GPS), or the like, is sometimes provided as aggregate data such that it is not possible to trace individuals. Aggregate data refers to data in which samples have been aggregated at a certain degree of spatial and temporal granularity. Specifically, the number of people flowing out from an observation point i (outflow number) and the number of people flowing in at the observation point i (inflow number) at a given time step t may be provided. In conventional technology, collective flow diffusion models (CFDM) have been proposed as existing approaches to estimate people flows in which connections, connecting between observation points and along which people move, are expressed using graphs, the flow of people on such graphs is expressed using probabilistic modeling, and based on the aggregate data, both the number of people moving between observation points and future flow volumes of people are estimated (see for example Non-Patent Documents 1 and 2). In CFDM people flow is estimated by solving an optimization problem that considers a constraint expressed by “conservation of number of moving people”, namely a constraint of “a total number of people flowing out from all observation points in a time step t is equal to the total number of people flowing in at all observation points in the same time step t”.

As an improvement to CFDM, an approach has been proposed in which movement times between observation points are built into the model in order to simultaneously estimate a distribution of movement times (see Non-Patent Document 3). The approach of Non-Patent Document 3 is known to be effective in cases in which there is a small number of observation points and a time lag arises between inflow and outflow of people at the observation points.

### Non-Patent Documents

Non-Patent Document 1: “Collective Diffusion over Networks: Models and Inference” by A. Kumar, D. Sheldon, and B. Srivastava in Proceedings of International Conference on Uncertainty in Artificial Intelligence (UAI), 2013, pp. 351 to 360
Non-Patent Document 2: “Approximate Inference in Collective Graphical Models” by D. Sheldon, T. Sun, A. Kumar, and T. G. Dietterich in Proceedings of International Conference on Machine Learning (ICML), 2013, pp. 1004 to 1012
Non-Patent Document 3: “Estimating Latent People Flow without Tracking Individuals” by Y. Tanaka, T. Iwata, T. Kurashima, H. Toda, and N. Ueda in IJCAI'18, 2018, pp. 3556 to 3563

### SUMMARY OF INVENTION

### Technical Problem

However, when applying such conventional approaches to real-life problems, there is no guarantee that the constraint expressed by “conservation of number of moving people” will always be satisfied. Namely, the precision of people flow estimation drops since no consideration is given to (1) cases in which the total number of people subject to observation fluctuates or (2) cases in which an observable range is limited.

In consideration of the above circumstances, an object of technology disclosed herein is to provide a people flow estimation device, a people flow estimation method, and a people flow estimation program capable of estimating flow volumes of people at respective observation points at respective time steps with good precision.

### Solution to Problem

A first aspect of the present disclosure is a people flow estimation device including a parameter estimation section configured to estimate a parameter for transition probability, a parameter for inflow noise, a parameter for outflow noise, and a number of moving people based on inflow data and outflow data so as to optimize an objective function. The inflow data is aggregate data made up of an inflow number of people at each time step for each of plural observation points. The outflow data is aggregate data made up of an outflow number of people at each time step for each of the plural observation points. The objective function is expressed using the inflow data, the outflow data, the number of moving people that is the number of people that have moved between each of the plurality of observation points at each time step, the transition probability of a person moving from one of the observation points to another of the observation points for each of respective pairs of the observation points at each time step, inflow noise that is noise in the inflow number of people at each time step for each of the plural observation points, and outflow noise that is noise in the outflow number of people at each time step for each of the plural observation points.

A second aspect of the present disclosure is a people flow estimation method in which a parameter estimation section estimates a parameter for transition probability, a parameter for inflow noise, a parameter for outflow noise, and a number of moving people based on inflow data and outflow data so as to optimize an objective function. The inflow data is aggregate data made up of an inflow number of people at each time step for each of plural observation points. The outflow data is aggregate data made up of an outflow number of people at each time step for each of the plural observation points. The objective function is expressed using the inflow data, the outflow data, the number of moving people that is the number of people that have moved between each of the plurality of observation points at each time step, the transition probability of a person moving from one of the observation points to another of the observation points for each of respective pairs of the observation points at each time step, inflow noise that is noise in the inflow number of people at each time step for each of the plural observation points, and outflow noise that is noise in the outflow number of people at each time step for each of the plural observation points.

### Advantageous Effects

The technology of the present disclosure enables flow volumes of people at respective observation points at respective time steps to be estimated with good precision.

### BRIEF DESCRIPTION OF DRAWINGS

FIG. 1 is a block diagram illustrating a schematic configuration of a computer that functions as a people flow estimation device according to an exemplary embodiment.

FIG. 2 is a block diagram illustrating an example of functional configuration of a people flow estimation device according to an exemplary embodiment.

FIG. 3 is a diagram illustrating an example of output of a people flow estimation device according to an exemplary embodiment.

FIG. 4 is a flowchart illustrating a people flow estimation processing routine of a people flow estimation device according to an exemplary embodiment.

FIG. 5 is a flowchart illustrating a parameter estimation processing routine of a people flow estimation device according to an exemplary embodiment.

### DESCRIPTION OF EMBODIMENTS

Outline of People Flow Estimation Device According to Exemplary Embodiment of Technology Disclosed Herein

First an outline of a people flow estimation device according to an exemplary embodiment will be described.

Conventional technology is capable of estimating a flow of people from aggregate data by solving an optimization problem that considers a constraint expressed by “conservation of number of moving people” in which “a total number of people flowing out from all observation points in a time step t is equal to the total number of people flowing in at all observation points in the same time step t”. However, when applied to real-life problems, there is no guarantee that the constraint expressed by “conservation of number of moving people” will always be satisfied. In the present disclosure, the following two factors are considered as factors potentially causing the constraint expressed by “conservation of number of moving people” not to be met.

1. Fluctuation of Total Number of People Subject to Observation

As an example, a case is considered in which position information is acquired in an exhibition hall. Sensors are installed at event booths in the exhibition hall to enable an inflow number and an outflow number of people at each event booth to be acquired for respective time steps. Since people enter and leave the exhibition hall, the total number of people inside the exhibition hall will fluctuate. Namely, the inflow number will include “people who have just arrived at the venue” and the outflow number will include “people who have left the venue”. In such cases, the constraint of “conservation of number of moving people” will therefore not be satisfied.

2. Limitations to Observable Range.

We will now consider the example of an exhibition hall, similarly to above. In the case of a large exhibition hall, from a cost perspective it would not be realistic to install a large number of sensors in an attempt to achieve blanket coverage of the venue. In such a situation in which the number of sensors is limited, it is difficult to observe every person subject to observation at every time step. Not every person that sets off at a given time step t will arrive at another booth within the same time step. The constraint of “conservation of number of moving people” will therefore not be satisfied in such cases.

An issue arises of the precision of people flow estimation dropping in the conventional technology due to not simultaneously considering the aforementioned two factors. In consideration of the above circumstances, one objective of the present disclosure is (1) to implement robust people flow estimation based on aggregate data by assuming a noise model applies to the inflow numbers and outflow numbers at each observation point. Another objective of the present disclosure is (2) to implement robust people flow estimation based on aggregate data by incorporating the movement time between observation point into the constraint of “conservation of number of moving people”. The following technique 1 and Technique 2 are disclosed as techniques for achieving these objects.

Technique 1: Probabilistic Model and Parameter Estimation Technique Considering Noise

Technique 1 estimates unknown variables of a probabilistic model from aggregate data by employing an EM algorithm, based on a probabilistic model having unknown variables of a “probabilistic distribution of transition of people between observation points”, a “number of people that moved between each observation point at each time step”, a “probabilistic distribution of inflow numbers at each observation point”, and a “probabilistic distribution of outflow numbers at each observation point”.

Since people enter and leave a range being observed (for example an exhibition hall), the total number of people present in the venue will fluctuate. Namely, the inflow number includes “people who have just arrived at the venue” and the outflow number includes “people who have left the venue”. In such cases the constraint of “conservation of number of moving people” might not be satisfied. Technique 1 has the advantageous effect of enabling robust people flow estimation to be performed while considering a magnitude of noise (a strength of a constraint) at each observation point by introducing the “probabilistic distribution of inflow numbers at each observation point”, and the “probabilistic distribution of outflow numbers at each observation point”.

Technique 2: Probabilistic Models and Parameter Estimation Technique Considering Noise and Movement Time

Technique 2 estimates unknown variables of a probabilistic model from aggregate data by employing an EM algorithm, based on a probabilistic model having unknown variables of a “probabilistic distribution of transition of people between observation points”, a “number of people that moved between each observation point at each time step”, a “probabilistic distribution of inflow numbers at each observation point”, a “probabilistic distribution of outflow numbers at each observation point”, and a “distribution of movement times between each observation point”.

In addition to the advantageous effect of Technique 1, for Technique 2 there is also the advantageous effect of enabling robust people flow estimation to be performed by incorporating the “distribution of movement times between each observation point” into the constraint of “conservation of number of moving people”, even in cases in which it would be difficult to observe every person subject to observation at every time step in a situation in which there is a limited number of sensors.

Configuration of People Flow Estimation Device According to Exemplary Embodiment of Technology Disclosed Herein

Explanation follows regarding an example of an exemplary embodiment of technology disclosed herein, with reference to the drawings. Note that the same or equivalent configuration elements and parts are allocated the same reference numerals in each of the drawings. Moreover, proportional dimensions in the drawings may be exaggerated in order to aid explanation, and may therefore differ from the actual proportions.

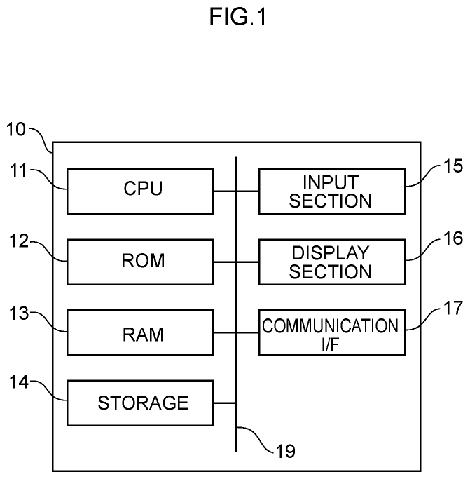

FIG. 1 is a block diagram illustrating a hardware configuration of a people flow estimation device 10 according to the present exemplary embodiment. As illustrated in FIG. 1, the people flow estimation device 10 includes a central processing unit (CPU) 11, read only memory (ROM) 12, random access memory (RAM) 13, storage 14, an input section 15, a display section 16, and a communication interface (I/F) 17. The respective configurations are connected together through a bus 19 so as to be capable of communicating with each other.

The CPU 11 is a central processing unit that executes various programs and controls various sections. Namely, the CPU 11 reads a program from the ROM 12 or the storage 14, and executes the program using the RAM 13 as a workspace. The CPU 11 controls the various configurations mentioned above and performs various types of arithmetic processing according to programs stored in the ROM 12 or the storage 14. In the present exemplary embodiment, the ROM 12 or the storage 14 is stored with a people flow estimation program used to execute processing including parameter estimation processing.

The ROM 12 is stored with various programs and various data. The RAM 13 serves as a workspace that temporarily stores programs or other data. The storage 14 is configured by a hard disk drive (HDD) or a solid state drive (SSD), and is stored with various programs including an operating system, as well as various other data.

The input section 15 includes a pointing device such as a mouse, as well as a keyboard, and is used to perform various input.

The display section 16 is, for example, a liquid crystal display and displays various information. The display section 16 may employ a touch panel so as to further function as the input section 15.

The communication interface 17 is an interface for communicating with other equipment, such as an external device (not illustrated in the drawings), and may employ a standard such as Ethernet (registered trademark), FDDI, Wi-Fi (registered trademark) or the like.

Next, explanation follows regarding functional configuration of the people flow estimation device 10.

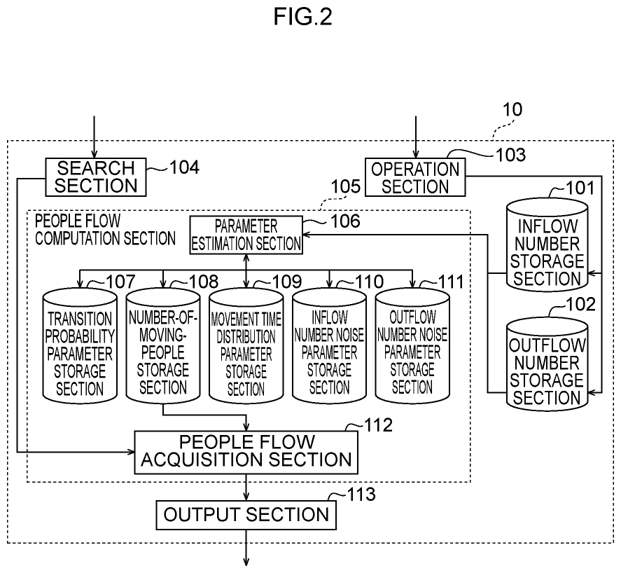

FIG. 2 is a block diagram illustrating an example of functional configuration of the people flow estimation device 10. As illustrated in FIG. 2, the people flow estimation device 10 includes an inflow number storage section 101, an outflow number storage section 102, an operation section 103, a search section 104, a people flow computation section 105, and an output section 113 as functional configurations. Each of these functional configurations is implemented by the CPU 11 reading the people flow estimation program stored in the ROM 12 or the storage 14 and expanding and executing the people flow estimation program in the RAM 13.

The inflow number storage section 101 is stored with inflow data, this being aggregate data made up of inflow numbers of people at each of plural observation points at each time step. The term aggregate data refers to data in which samples have been aggregated at a certain degree of spatial and temporal granularity. The data employed here is data configured so as to not allow tracking for an given individual of “wherefrom and whereto the individual moved”. As an example, explanation follows regarding people flow estimation in a case in which the aggregate data provided from generic position information is provided under the following conditions.

Specifically, the inflow number storage section 101 is stored with inflow data Yⁱⁿ analyzable by the people flow computation section 105. The inflow number storage section 101 reads the inflow data Yⁱⁿ according to a request from the people flow computation section 105, and transmits the inflow data Yⁱⁿ to the people flow computation section 105. When an observation point is denoted i and a time step is denoted t, the inflow number for the observation point i at the time step t is expressed as Yⁱⁿ_{t,i}. Note that Yⁱⁿ_{t,i} expresses the total number of people who have flowed into the observation point i in a time interval (t−1, t). The inflow data Yⁱⁿ stored in the inflow number storage section 101 is expressed by the following equation.

Yⁱⁿ={Y_{t,i}ⁱⁿ|t=1, . . . ,T;i∈V}

In the above equation, T is the total number of time steps, and the set V (the bold letter V in the equation; hereafter denoted simply using a letter V in the specification) is a set including all observation points.

The outflow number storage section 102 is stored with outflow data, this being aggregate data made up from the outflow number of people at each of the plural observation points at each time step.

Specifically, the outflow number storage section 102 is stored with outflow data Y^{out} analyzable by the people flow computation section 105. The outflow number storage section 102 reads the outflow data Y^{out} according to a request from the people flow computation section 105, and transmits the outflow data Y^{out} to the people flow computation section 105. An outflow volume at the observation point i at the time step t is expressed as Y^{out}_{t,i}. Note that Y^{out}_{t,i} expresses the total number of people who have flowed out from the observation point i in the time interval (t−1, t). The outflow data Y^{out} stored in the outflow number storage section 102 is expressed by the following equation.

Y^{out}={Y_{t,i}^{out}|t=1, . . . ,T;i∈V}

Note that the inflow number storage section 101 and the outflow number storage section 102 may be configured by a web server and a database server or the like provided with a database.

The operation section 103 receives various operations from a user with respect to the aggregate data stored in the inflow number storage section 101 and the outflow number storage section 102. The respective operations include operations to register, correct, or delete data. The operation section 103 further performs operations with respect to the aggregate data stored in the inflow number storage section 101 and the outflow number storage section 102 in response to the various operations received. The aggregate data stored in the inflow number storage section 101 and the outflow number storage section 102 is stored in advance by the operation section 103 based on respective operations received from the user.

The search section 104 receives input of a target time step t that is to be subject to people flow estimation. The search section 104 then passes the received target time step t to the people flow computation section 105.

The people flow computation section 105 estimates parameters for performing people flow estimation and a number of moving people for each observation point. Specifically, the people flow computation section 105 includes a parameter estimation section 106, a transition probability parameter storage section 107, a number-of-moving-people storage section 108, a movement time distribution parameter storage section 109, an inflow number noise parameter storage section 110, an outflow number noise parameter storage section 111, and a people flow acquisition section 112.

The parameter estimation section 106 estimates a transition probability parameter, an inflow noise parameter, an outflow noise parameter, a parameter of a movement time distribution, and a number of moving people so as to optimize an objective function based on inflow data and outflow data. The inflow data is aggregate data made up of the inflow number of people at each time step for each of plural observation points, and the outflow data is aggregate data made up of the outflow number of people at each time step for each of the plural observation points. The objective function is expressed using the inflow data, the outflow data, the number of moving people that is the number of people that have moved between each of the observation points at each time step, transition probabilities of people moving from one observation point to another observation point for each of respective pairs of observation points at each time step, inflow noise that is noise in the inflow number of people at each time step for each of the plural observation points, outflow noise that is noise in the outflow number of people at each time step for each of the plural observation points, and a movement time distribution representing a distribution of movement times from one observation point to another observation point for the respective observation point pairs.

Specifically, the parameter estimation section 106 repeats an E step and an M step of an EM algorithm in order to estimate a transition probability parameter, an inflow noise parameter, an outflow noise parameter, a parameter of a movement time distribution, and a number of moving people so as to optimize the objective function. At the E step, the transition probability parameter, the inflow noise parameter, the outflow noise parameter, and the parameter for the movement time distribution are fixed and the number of moving people is estimated. At the M step, the number of moving people as estimated at the E step is employed to estimate the transition probability parameter, the inflow noise parameter, the outflow noise parameter, and the parameter for the movement time distribution.

The parameter estimation section 106 employs the inflow data and the outflow data as training data, and incorporates the transition probability parameter, the inflow noise parameter, the outflow noise parameter, the parameter for the movement time distribution, and the number of moving people as the unknown variables and expresses the connections between observation points as a graph. The parameter estimation section 106 expresses the flow of people on the graph using a probabilistic model, and performs estimation using an EM algorithm. Explanation follows regarding the probabilistic model and the parameter estimation method.

A transition probability of moving from the observation point i to an observation point j is taken as being θᵢⱼ≥0 and is assumed to satisfy the following equation.

Σ_{j∈E}_{ᵢ}θᵢⱼ=1

Eᵢ (the bold letter E in the equation) is Eᵢ⊂V and represents a set of observation points in the vicinity of the observation point i. N^{out}_{t,i} is a latent variable representing a number of people obtained by removing noise from Y^{out}_{y,i}, and Nⁱⁿ_{t,i} is a latent variable representing a number of people obtained by removing noise from Yⁱⁿ_{t,i}. Moreover, a number of people setting off from the observation point i during the time step t and subsequently arriving at the observation point j is denoted Mₜᵢⱼ, and the number of people moving from the observation point i is summarized in the following equation.

Mₜᵢ={Mₜᵢⱼ|j∈Eᵢ}

When given an inflow number N^{out}_{t,i}, the number of people moving Mₜᵢ from i is assumed to be generated according to a multinomial distribution expressed by Equation (1) below.

$$P ( {M}_{ti} \vert {N}_{t , i}^{out} , {θ}_{i} ) = \frac{{N}_{t , i}^{out} !}{{\prod }_{j ∈ {E}_{i}} {M}_{tij} !} {\prod }_{j ∈ {E}_{i}} {θ}_{ij}^{{M}_{tij}} \qquad ( 1 )$$

θᵢ is expressed by the following equation.

θᵢ={θᵢⱼ|j∈Eᵢ}

Next, two constraints expressing the “conservation of number of moving people” are taken as being Equation (2) and Equation (3) below.

$$\begin{matrix}{N}_{t , i}^{out} = {\sum }_{j ∈ {E}_{i}} {M}_{tij} , & ( 2 ) \\ {N}_{t , i}^{in} = {\sum }_{j ∈ {E}_{i}} {{\sum }_{τ = 1}}^{t} F ( {Δ}_{t , τ} ; {γ}_{ji} ) {M}_{τ ji} & ( 3 )\end{matrix}$$

Equation (2) expresses the conservation of the number of people flowing out from the observation point i at the time step t. Equation (3) expresses the conservation of the number of people flowing into the observation point i at the time step t. Δ_{t,τ}=t−τ represents movement time, τ represents a departure time step, and t represents an arrival time step. F(Δ_{t,τ};γⱼᵢ)≥0 is a movement time probability, and represents a probability of the time taken to move from the observation point j to the observation point i being Δ_{t,τ}. γⱼᵢ is a parameter used to decide a scale of the movement time distribution.

Next, explanation follows regarding a specific method for calculating the movement time probability F. First, taking f(Δ;γⱼᵢ) as movement time distribution in continuous time with a variable representing continuous time of Δ>0. Various probability density functions may conceivably be employed as f(Δ;γⱼᵢ). The table below illustrates an example of a case in which an exponential distribution and a Rayleigh distribution are employed therefor.

TABLE 1

| | Movement Time | Movement Time |
|---|---|---|
| | Distribution f(Δ; γⱼᵢ) | Probability F(Δ_{t,τ}; γⱼᵢ) |
| Exponential Distribution | $\{ \begin{matrix}{γ}_{ij} {e}^{- {γ}_{ji} Δ} & if 0 \leq Δ \\ 0 & otherwise\end{matrix}$ | e^{-γ}^{ⱼᵢ}^{Δ}^{_{t,τ}} − e^{-γ}^{ⱼᵢ}^{(Δ}^{_{t,τ}}⁺¹⁾ |
| Rayleigh Distribution | $\{ \begin{matrix}{γ}_{ij} Δ {e}^{- \frac{1}{2} {γ}_{ji} {Δ}^{2}} & if 0 \leq Δ \\ 0 & otherwise\end{matrix}$ | ${e}^{- \frac{1}{2} {{γ}_{ji} ( {Δ}_{t , τ} )}^{2}} - {e}^{- \frac{1}{2} {{γ}_{ji} ( {Δ}_{t , τ} + 1 )}^{2}}$ |

A value obtained by integrating the movement time distribution f(Δ;γⱼᵢ) for each time interval [Δ_{t,τ}, Δ_{t,τ+1}] calculated as in Equation (4) below. Equation (4) is employed as a movement time probability.

F(Δ_{t,τ};γⱼᵢ)=∫_{Δt,τ}^{Δ}^{_{t,τ}}⁺¹f(Δ;γⱼᵢ)dΔ (4)

Next, a situation is considered in which Equation (2) and Equation (3) representing the two constraints expressing the “conservation of number of moving people” are not satisfied as a result of noise. The observations Y^{out}_{t,i} and Yⁱⁿ_{t,i} are assumed to be generated according to a Gaussian distribution expressed by Equation (5) and Equation (6) below in which N^{out}_{t,i} and Nⁱⁿ_{t,i} are respective averages thereof.

$$\begin{matrix}p ( {Y}_{t , i}^{out} \vert {N}_{t , i}^{out} , {σ}_{i}^{2} ) = \frac{1}{\sqrt{2 {πσ}_{i}^{2}}} exp ( - \frac{1}{2 {σ}_{i}^{2}} {( {Y}_{t , i}^{out} - {N}_{t , i}^{out} )}^{2} ) & ( 5 ) \\ p ( {Y}_{t , i}^{in} \vert {N}_{t , i}^{in} , {λ}_{i}^{2} ) = \frac{1}{\sqrt{2 {πλ}_{i}^{2}}} exp ( - \frac{1}{2 {λ}_{i}^{2}} {( {Y}_{t , i}^{in} - {N}_{t , i}^{in} )}^{2} ) & ( 6 )\end{matrix}$$

σᵢ²>0 and λᵢ²>0 are parameters (referred to hereafter as noise parameters) representing noise variance with respect to the inflow number and the outflow number at the observation point i. These noise parameters have a role of controlling to what extent to consider the constraints expressing the “conservation of number of moving people” at each observation point.

The parameters to be estimated in the parameter estimation section 106 are as follows:

a transition probability parameter

Θ={θᵢ|i∈V};

a parameter of a movement time distribution

Γ{γᵢⱼ|i∈V;j∈Eᵢ};

an outflow number noise parameter

Σ={σᵢ|i∈V};

and an inflow number noise parameter

Λ={λᵢ|i∈V}.

Next, explanation follows regarding a method employed by the parameter estimation section 106 to estimate parameters based on an EM algorithm. All the parameters to be estimated are collectively written as Φ={Θ, Γ, Σ, Λ}. A Q function denoted by Q (Φ\hat{ }, Φ) can be written as in Equation (7) below. Note that X\hat{ } is written with the “\hat{ }” above symbols X in the equation.

$$Q ( \hat{Φ} , Φ ) = {\sum }_{M} p ( M \vert {Y}^{out} , {Y}^{in} , \hat{Φ} ) log p ( {Y}^{out} , {Y}^{in} , M \vert Φ ) \qquad ( 7 )$$

Φ\hat{ }={Θ\hat{ }, Γ\hat{ }, Σ\hat{ }, Λ\hat{ }} represent current estimated values. The sum of all M in Equation (7) is difficult to calculate from the perspective of computation size. Accordingly, the Q function is calculated by approximation as expressed as Equation (8) below.

Q^{approx}(\hat{Φ},Φ)=log p(Y^{out},Yⁱⁿ,\hat{M}|Φ) (8)

M\hat{ } is a MAP estimated value found by maximizing the posteriori probability, as in Equation (9) below.

$$\hat{M} = {arg max}_{M} log p ( M \vert {Y}^{out} , {Y}^{in} , \hat{Φ} ) \qquad ( 9 )$$

A similar approximation method is introduced in Non-Patent Document 2. Non-Patent Document 2 provides the results of computer experiments and demonstrates that appropriate parameter estimation can be performed. In the EM algorithm procedure, Equation (9) is solved at the E step so as to estimate the MAP estimated value M\hat{ }, and Φ is estimated at the M step so as to maximize the Q function in Equation (8). The parameter estimation section 106 repeats the E step and the M step until fluctuations in value converge. Explanation follows regarding specific optimization problems to solve at the E step and the M step.

E Step

Explanation follows regarding the E step. Assume that the current parameter estimated value Φ\hat{ } has been given. Bayes' theorem is employed to enable a posteriori distribution of M to be written as in Equation (10) below.

$$log p ( M \vert {Y}^{out} , {Y}^{in} , \hat{Φ} ) ∝ log p ( {Y}^{out} , {Y}^{in} , M \vert Φ ) \approx {\sum }_{t = 1}^{T} {\sum }_{i ∈ V} [ - \frac{1}{2 {\hat{σ}}_{i}^{2}} {( {Y}_{t , i}^{out} - {\sum }_{j ∈ {E}_{i}} {M}_{tij} )}^{2} - \frac{1}{2 {\hat{λ}}_{i}^{2}} {( {Y}_{t , i}^{in} - {\sum }_{j ∈ {E}_{i}} {\sum }_{τ = 1}^{t} F ( {Δ}_{t , τ} ; {\hat{γ}}_{ji} ) {M}_{τ ji} )}^{2} + ( {\sum }_{j ∈ {E}_{i}} {M}_{tij} ) log ( {\sum }_{j ∈ {E}_{i}} {M}_{tij} ) + {\sum }_{j ∈ {E}_{i}} ( {M}_{tij} log {\hat{θ}}_{ij} - {M}_{tij} log {M}_{tij} ) ] = : ℒ ( M ) \qquad ( 10 )$$

The constraint formulae expressing the “conservation of number of moving people” of Equation (2) and Equation (3) are substituted into Equation (9). Stirling's approximation

log n!≈n log n−n

is then employed to approximate log Mₜᵢⱼ! and

(Σ_{j∈E}_{ᵢ}Mₜᵢⱼ)!.

In Equation (10), an objective function relating to M is denoted L(M). From the above, the optimization problem to be solved at the E step is as set out in Equation (11) below.

$$\begin{matrix}{maximize}_{M} & ℒ ( M )\end{matrix} \\ \begin{matrix}subject to & {M}_{tij}\end{matrix} \geq 0 , t = 1 , … , T ; i ∈ V ; j ∈ {E}_{i} \qquad ( 11 )$$

Equation (11) can, for example, be solved by employing an L-BFGS-B method (see Reference Document 1).

Reference Document 1: “A Limited Memory Algorithm for Bound Constrained Optimization” by R. H. Byrd, P. Lu, J. Nocedal, and C. Zhu, in SIAM Journal on Scientific Computing, 1995, 16: pp. 1190 to 1208

M Step

Next, explanation follows regarding the M step. Assuming that the current estimated value M\hat{ } for the number of moving people has been given, an approximation of the Q function is written as in Equation (12) below.

$${Q}^{approx} ( \hat{Φ} , Φ ) = log p ( {Y}^{out} , {Y}^{in} , \hat{M} \vert Φ ) \approx {\sum }_{t = 1}^{T} {\sum }_{i ∈ V} [ - \frac{1}{2} log {σ}_{i}^{2} - \frac{1}{2} {{σ}_{i}^{2} ( {Y}_{t , i}^{out} - {\sum }_{j ∈ {E}_{i}} {\hat{M}}_{tij} )}^{2} - \frac{1}{2} log {λ}_{i}^{2} - \frac{1}{2 {λ}_{i}^{2}} {( {Y}_{t , i}^{in} - {\sum }_{j ∈ {E}_{i}} {\sum }_{τ = 1}^{t} F ( {Δ}_{t , τ} ; {γ}_{ji} ) {\hat{M}}_{τ ji} )}^{2} + {\sum }_{j ∈ {E}_{i}} {\hat{M}}_{tij} log {θ}_{ij} ] = : 𝒥 ( Θ , Γ , \sum , Λ ) \qquad ( 12 )$$

An objective function relating to the parameters is given by J (Θ, Γ, Σ, Λ). The Lagrange multiplier method is employed to give the estimated value of θᵢⱼ as in Equation (13) below.

$${θ}_{ij} = \frac{{\sum }_{t = 1}^{T} {\hat{M}}_{tij}}{{\sum }_{t = 1}^{T} {\sum }_{j ∈ {E}_{i}} {\hat{M}}_{tij}} \qquad ( 13 )$$

The other parameters Γ, Σ, and Λ are found by solving the optimization problem expressed by Equation (14) below.

$$\begin{matrix}{maximize}_{Γ , \sum , Λ} & 𝒥 ( Θ , Γ , \sum , Λ )\end{matrix} \\ \begin{matrix}subject to & {γ}_{ij}\end{matrix} > 0 , i ∈ V ; j ∈ {E}_{i} \qquad ( 14 )$$

The parameter estimation section 106 then repeats the E step and the M step until fluctuations in the values of the parameters Φ\hat{ } and of the number of moving people M\hat{ } converge. The parameter estimation section 106 stores the found Θ\hat{ } in the transition probability parameter storage section 107 as the parameter for transition probability. The parameter estimation section 106 stores the found M\hat{ } in the number-of-moving-people storage section 108 as the number of moving people. The parameter estimation section 106 stores the found Γ\hat{ } in the movement time distribution parameter storage section 109 as the parameter for movement time distribution. The parameter estimation section 106 stores the found Λ\hat{ } in the inflow number noise parameter storage section 110 as the parameter for inflow noise. The parameter estimation section 106 stores the found Σ\hat{ } in the outflow number noise parameter storage section 111 as the outflow noise parameter.

The transition probability parameter storage section 107 is stored with the transition probability parameter Θ\hat{ } estimated by the parameter estimation section 106. The number-of-moving-people storage section 108 is stored with the number of moving people M\hat{ } estimated by the parameter estimation section 106. The movement time distribution parameter storage section 109 is stored with the parameter for the movement time distribution Γ\hat{ } estimated by the parameter estimation section 106. The inflow number noise parameter storage section 110 is stored with the inflow noise parameter Λ\hat{ } estimated by the parameter estimation section 106. The outflow number noise parameter storage section 111 is stored with the outflow noise parameter Σ\hat{ } estimated by the parameter estimation section 106. The transition probability parameter storage section 107, the number-of-moving-people storage section 108, the movement time distribution parameter storage section 109, the inflow number noise parameter storage section 110, and the outflow number noise parameter storage section 111 may have any configuration as long as the stored estimated values are saved so as to be recoverable. For example, storage may be performed in a database or in a designated area of a pre-prepared generic storage device (such as memory or a hard disk device).

The people flow acquisition section 112 acquires the number of moving people M\hat{ } at the target time step t received by the search section 104 from the number-of-moving-people storage section 108. The people flow acquisition section 112 then passes the acquired number of moving people M\hat{ } at the target time step t to the output section 113.

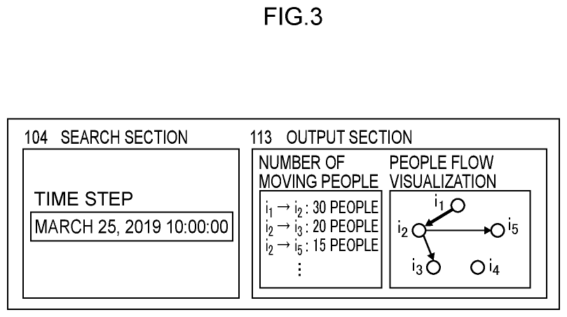

The output section 113 outputs the number of people moving between each of the observation points based on the number of moving people M\hat{ } at the target time step t. Specifically, the output section 113 outputs the number of people moving between each of the observation points at the target time step t to the display section 16. FIG. 3 illustrates an example of output by the output section 113 in a case in which there are five observation points (i₁, i₂, i₃, i₄, i₅) present. The output section 113 accepts from the search section 104 the target time step subject to analysis, and displays the number of people moving between the five observation points and visualization results accordingly. The thickness of arrows employed in the visualization results is determined so as to be proportional to the number of people moving between the relevant observation points. For example, this output example may be employed to ascertain behavioral patterns of people within an exhibition hall, which may then be utilized when developing navigation and countermeasures to congestion.

Operation of People Flow Estimation Device According to Exemplary Embodiment of Technology Disclosed Herein

Next, explanation follows regarding operation of the people flow estimation device 10.

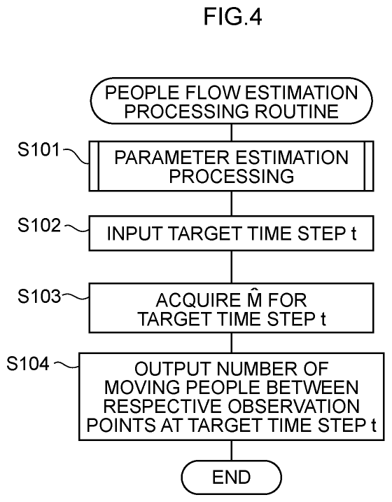

FIG. 4 is a flowchart illustrating a flow of people flow estimation processing by the people flow estimation device 10. The CPU 11 performs the people flow estimation processing by reading a parameter estimation program from the ROM 12 or the storage 14 and expanding and executing the parameter estimation program in the RAM 13.

At step S101, the CPU 11 functions as the parameter estimation section 106 to estimate the transition probability parameter, the inflow noise parameter, the outflow noise parameter, the parameter for the movement time distribution, and the number of moving people based on inflow data and outflow data so as to optimize an objective function. The inflow data is aggregate data made up of the inflow number of people at each time step for each of the plural observation points, and the outflow data is aggregate data made up of the outflow number of people at each time step for each of the plural observation points. The objective function is expressed using the inflow data, the outflow data, the number of moving people that is the number of people that have moved between each of the observation points at each time step, transition probabilities of people moving from one observation point to another observation point for respective pairs of observation points at each time step, the inflow noise of noise in the inflow number of people at each time step for each of the plural observation points, outflow noise of noise in the outflow number of people at each time step for each of the plural observation points, and a movement time distribution representing a distribution of movement times from one observation point to another observation point for the respective observation point pairs.

At step S102, the CPU 11 functions as the search section 104 to receive input of the target time step t subject to people flow estimation.

At step S103, the CPU 11 functions as the people flow acquisition section 112 to acquire the number of moving people M\hat{ } at the target time step t received at step S102 from the number-of-moving-people storage section 108.

At step S104, the CPU 11 functions as the output section 113 to output the number of people moving between each observation point based on the number of moving people M\hat{ } at the target time step t acquired at step S103. The processing is then ended.

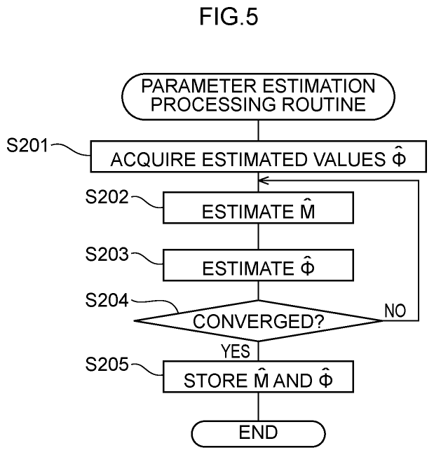

Explanation follows regarding the parameter estimation processing of step S101. FIG. 5 is a flowchart illustrating a parameter estimation processing routine performed at step S101.

At step S201, the CPU 11 functions as the parameter estimation section 106 to acquire predetermined initial values of Φ as the current Φ\hat{ } from the transition probability parameter storage section 107, the movement time distribution parameter storage section 109, the inflow number noise parameter storage section 110, and the outflow number noise parameter storage section 111.

At step S202, the CPU 11 functions as the parameter estimation section 106 to execute the E step by fixing the transition probability parameter Θ\hat{ }, the inflow noise parameter Λ\hat{ }, the outflow noise parameter Σ\hat{ }, and the parameter for the movement time distribution Γ\hat{ } and estimating the number of moving people M\hat{ }.

At step S203, the CPU 11 functions as the parameter estimation section 106 to execute the M step by employing the number of moving people M\hat{ } estimated at step S202 to estimate the transition probability parameter Θ\hat{ }, the inflow noise parameter Λ\hat{ }, the outflow noise parameter Σ\hat{ }, and the parameter for the movement time distribution Γ\hat{ }.

At step S204, the CPU 11 functions as the parameter estimation section 106 to determine whether or not the fluctuations in value have converged.

In cases in which the fluctuations in value have not converged (step S204: NO), the CPU 11 returns to step S202. On the other hand, in cases in which the fluctuations in value have converged (step S204: YES), then at step S205 the CPU 11 functions as the parameter estimation section 106 to store the found η\hat{ } in the transition probability parameter storage section 107 as the transition probability parameter. The CPU 11 also stores the found M\hat{ } as the number of moving people in the number-of-moving-people storage section 108. The CPU 11 also stores the found Γ\hat{ } as the parameter for the movement time distribution in the movement time distribution parameter storage section 109. The CPU 11 also stores the found Λ\hat{ } as the inflow noise parameter in the inflow number noise parameter storage section 110. The CPU 11 also stores the found Σ\hat{ } as the outflow noise parameter in the outflow number noise parameter storage section 111. The processing then returns.

As described above, the people flow estimation device according to the present disclosure estimates the transition probability parameter, the inflow noise parameter, the outflow noise parameter, and the number of moving people based on inflow data and outflow data so as to optimize the objective function. The inflow data is aggregate data made up of the inflow number of people at each time step for each of the plural observation points, and the outflow data is aggregate data made up of the outflow number of people at each time step for each of the plural observation points. The objective function is expressed using the inflow data, the outflow data, the number of moving people that is the number of people that have moved between each of the observation points at each time step, transition probabilities of people moving from one observation point to another observation point for each of respective pairs of the observation points at each time step, inflow noise that is noise in the inflow number of people at each time step for each of the plural observation points, and outflow noise that is noise in the outflow number of people at each time step for each of the plural observation points. This enables parameter estimation that considers noise to be implemented for the constraint of the “conservation of number of moving people”, and enables flow volumes of people between each of the observation points at each time step to be estimated with good precision.

Moreover, the people flow estimation device according to the present disclosure estimates the transition probability parameter, the inflow noise parameter, the outflow noise parameter, and the parameter for the movement time distribution, as well as the number of moving people so as to optimize the objective function expressed using the inflow data, the outflow data, the number of moving people, the transition probability, the inflow noise, the outflow noise, and the movement time distribution representing a distribution of movement times from one observation point to another observation point for the respective observation point pairs. This enables parameter estimation that considers noise and movement times to be implemented for the constraint of the “conservation of number of moving people”, and enables flow volumes of people between each of the observation points at each time step to be estimated with even better precision.

Note that the present disclosure is not limited to the exemplary embodiment described above, and various modifications and applications are possible within a range not departing from the spirit of the present disclosure.

For example, in the foregoing disclosure, the aggregate data is configured from generic position information. However there is no limitation thereto, and aggregate data configured by various types of position information may be employed. For example, application may be made to position information acquired from indoor and outdoor sensors (BLE or the like) and cameras, via Wi-Fi or the like, and application may be implemented flexibly according to the observation data.

Note that the people flow estimation program executed by the CPU reading in software (a program) in the exemplary embodiment described above may be executed by various types of processor other than a CPU. Examples of such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The people flow estimation program may be executed by any one of these various types of processor, or may be executed by a combination of two or more of the same type or different types of processor (such as plural FPGAs, or a combination of a CPU and an FPGA). The hardware structure of these various types of processors is more specifically an electric circuit combining circuit elements such as semiconductor elements.

Moreover, in the exemplary embodiment described above, explanation has been given regarding a mode in which the people flow estimation program is stored in advance (installed) in the storage 14. However, there is no limitation thereto. The program may be provided in a format recorded on a non-transitory storage medium such as a compact disk read only memory (CD-ROM), digital versatile disk read only memory (DVD-ROM), or universal serial bus (USB) memory. Alternatively, the program may be in a format downloadable from an external device over a network.

The following supplements are also disclosed in relation to the foregoing exemplary embodiment.

Supplement 1

A people flow estimation device comprising:

a memory;

at least one processor coupled to the memory, wherein

the processor estimates a parameter for transition probability, a parameter for inflow noise, a parameter for outflow noise, and a number of moving people based on inflow data and outflow data so as to optimize an objective function,

the inflow data being aggregate data made up of an inflow number of people at each time step for each of a plurality of observation points,

the outflow data being aggregate data made up of an outflow number of people at each time step for each of the plurality of observation points, and

the objective function being expressed using the inflow data, the outflow data, the number of moving people that is the number of people that have moved between each of the plurality of observation points at each time step, the transition probability of a person moving from one of the observation points to another of the observation points for each of respective pairs of the observation points at each time step, inflow noise that is noise in the inflow number of people at each time step for each of the plurality of observation points, and outflow noise that is noise in the outflow number of people at each time step for each of the plurality of observation points.

Supplement 2

A non-transitory storage medium storing a program executable by a computer so as to execute people flow estimation processing, the people flow estimation processing comprising:

estimating a parameter for transition probability, a parameter for inflow noise, a parameter for outflow noise, and a number of moving people based on inflow data and outflow data so as to optimize an objective function,

the inflow data being aggregate data made up of an inflow number of people at each time step for each of a plurality of observation points,

the outflow data being aggregate data made up of an outflow number of people at each time step for each of the plurality of observation points, and

the objective function being expressed using the inflow data, the outflow data, the number of moving people that is the number of people that have moved between each of the plurality of observation points at each time step, the transition probability of a person moving from one of the observation points to another of the observation points for each of respective pairs of the observation points at each time step, inflow noise that is noise in the inflow number of people at each time step for each of the plurality of observation points, and outflow noise that is noise in the outflow number of people at each time step for each of the plurality of observation points.

The disclosure of Japanese Patent Application No. 2019-128428 is incorporated in its entirety in the present specification by reference herein.

All cited documents, patent applications, and technical standards mentioned in the present specification are incorporated by reference in the present specification to the same extent as if each individual cited document, patent application, or technical standard was specifically and individually indicated to be incorporated by reference.

### EXPLANATION OF THE REFERENCE NUMERALS

10 people flow estimation device
11 CPU
12 ROM
13 RAM
14 storage
15 input section
16 display section
17 communication interface
19 bus
101 inflow number storage section
102 outflow number storage section
103 operation section
104 search section
105 people flow computation section
106 parameter estimation section
107 transition probability parameter storage section
108 number-of-moving-people storage section
109 movement time distribution parameter storage section
110 inflow number noise parameter storage section
111 outflow number noise parameter storage section
112 people flow acquisition section
113 output section

1. A people flow estimation device comprising:
a memory;
at least one processor coupled to the memory, wherein
the processor estimates a parameter for transition probability, a parameter for inflow noise, a parameter for outflow noise, and a number of moving people based on inflow data and outflow data so as to optimize an objective function,
the inflow data being aggregate data made up of an inflow number of people at each time step for each of a plurality of observation points,
the outflow data being aggregate data made up of an outflow number of people at each time step for each of the plurality of observation points, and
the objective function being expressed using the inflow data, the outflow data, the number of moving people that is a number of people that have moved between each of the plurality of observation points at each time step, the transition probability of a person moving from one of the observation points to another of the observation points for each of respective pairs of the observation points at each time step, inflow noise that is noise in the inflow number of people at each time step for each of the plurality of observation points, and outflow noise that is noise in the outflow number of people at each time step for each of the plurality of observation points.

2. The people flow estimation device of claim 1, wherein:
the objective function is expressed using the inflow data, the outflow data, the number of moving people, the transition probability, the inflow noise, the outflow noise, and a movement time distribution representing a distribution of movement times from one of the observation points to the other of the observation points for each pair of the observation points; and
the processor estimates the transition probability parameter, the inflow noise parameter, the outflow noise parameter, a parameter for the movement time distribution, and the number of moving people so as to optimize the objective function.

3. The people flow estimation device of claim 1, wherein:
the processor uses an EM algorithm to estimate the transition probability parameter, the inflow noise parameter, the outflow noise parameter, and the number of moving people so as to optimize the objective function by repeatedly performing:
an E step of fixing the transition probability parameter, the inflow noise parameter, and the outflow noise parameter and estimating the number of moving people, and
an M step of using the number of moving people estimated in the E step to estimate the transition probability parameter, the inflow noise parameter, and the outflow noise parameter.

4. The people flow estimation device of claim 2, wherein:
the processor uses an EM algorithm to estimate the transition probability parameter, the inflow noise parameter, the outflow noise parameter, the parameter for the movement time distribution, and the number of moving people so as to optimize the objective function by repeatedly performing:
an E step of fixing the transition probability parameter, the inflow noise parameter, the outflow noise parameter, and the parameter for the movement time distribution and estimating the number of moving people, and
an M step of using the number of moving people estimated in the E step to estimate the transition probability parameter, the inflow noise parameter, the outflow noise parameter, and the parameter for the movement time distribution.

5. The people flow estimation device of claim 1, further comprising:
a search section configured to receive input of a target time step to be subject to people flow estimation; and
an output section configured to output the number of moving people for each of the plurality of observation points for the target time step as estimated by processor.

6. A people flow estimation method comprising:
estimating a parameter for transition probability, a parameter for inflow noise, a parameter for outflow noise, and a number of moving people based on inflow data and outflow data so as to optimize an objective function, wherein:
the inflow data is aggregate data made up of an inflow number of people at each time step for each of a plurality of observation points,
the outflow data is aggregate data made up of an outflow number of people at each time step for each of the plurality of observation points, and
the objective function is expressed using the inflow data, the outflow data, the number of moving people that is a number of people that have moved between each of the plurality of observation points at each time step, the transition probability of a person moving from one of the observation points to another of the observation points for each of respective pairs of the observation points at each time step, inflow noise that is noise in the inflow number of people at each time step for each of the plurality of observation points, and outflow noise that is noise in the outflow number of people at each time step for each of the plurality of observation points.

7. A non-transitory storage medium storing a program executable by a computer so as to execute people flow estimation processing, the people flow estimation processing comprising:
estimating a parameter for transition probability, a parameter for inflow noise, a parameter for outflow noise, and a number of moving people based on inflow data and outflow data so as to optimize an objective function,
the inflow data being aggregate data made up of an inflow number of people at each time step for each of a plurality of observation points,
the outflow data being aggregate data made up of an outflow number of people at each time step for each of the plurality of observation points, and
the objective function being expressed using the inflow data, the outflow data, the number of moving people that is a number of people that have moved between each of the plurality of observation points at each time step, the transition probability of a person moving from one of the observation points to another of the observation points for each of respective pairs of the observation points at each time step, inflow noise that is noise in the inflow number of people at each time step for each of the plurality of observation points, and outflow noise that is noise in the outflow number of people at each time step for each of the plurality of observation points.
